(19) United States
(12) Patent Application Publication
(10) Pub. No.: US 2021/0326902 A1
(43) Pub. Date: Oct. 21, 2021

(54) SYSTEM AND METHOD FOR AUTHENTICATION OF A PRODUCT

(71) Applicant: PRASHANT ANIL KODRE, PUNE (IN)

(72) Inventor: PRASHANT ANIL KODRE, PUNE (IN)

(21) Appl. No.: 16/892,497

(22) Filed: Jun. 4, 2020

(30) Foreign Application Priority Data
Apr. 15, 2020 (IN) 202021016293

(51) Int. Cl. G06Q 30/00; G06Q 10/08; G06K 7/14

(52) U.S. Cl. CPC G06Q 30/0185; G06Q 2220/00; G06K 7/1413; G06Q 10/087

(57) ABSTRACT

System and method for authentication of a product are disclosed. The system includes one or more processors. The system also includes a registration module to register a plurality of users on a centralised platform. The system also includes a data retrieving module to retrieve data as provided by the plurality of users via the registration module. The system also includes a unique code generation module to generate a unique product code for real time analysis of the product. The system also includes a scanning module to detect the plurality of product details upon scanning the unique product code. The system also includes a product authentication module to authenticate the product during sale upon detecting the plurality of product details. The authenticity of the product during sale is determined by verifying a status of the product based on one or more historic scanning data.

### CROSS-REFERENCE TO RELATED APPLICATION

This application claims priority from a Patent Application filed in India bearing application no. 202021016293, filed on Apr. 15, 2020 and titled “SYSTEM AND METHOD FOR AUTHENTICATION OF A PRODUCT”.

### FIELD OF INVENTION

Embodiments of a present disclosure relates to counterfeit detection systems, and more particularly, to a system and method for authentication of a product during sale using unique identification code.

### BACKGROUND

Counterfeiting is a significant and continuing global problem for brand owners, manufacturers, retailers, and consumers. With increased world trade and with companies continually seeking to reduce the costs of production, many products are no longer produced by the manufacturers themselves or in the country where the company is incorporated. Whenever a consumer goes to the market to buy any product. He must rely on the details mentioned (printed) on the product/package. There is no system in place for consumers which can empower them to identify the product accurately and verify the labelling of the product or package, which can be false, altered, not visible, damaged, tampered or the like. Therefore, there exists a need for an improved system for detecting fake products or to identify the authenticity of the product. Also, not every manufacturer has the ability to monitor the product till the time it reaches to the hand of consumers

In such situation, well established companies are threatened most; mainly for the research extensive products. Major problems that any company faces due the fake products are reduced revenues, margin erosion, loss of reputation to negative brand image, service and warranty problems and reduced customer satisfaction. One may take specific example like automobile industry, where fake product usage will lead to fatalities. The problem starts whenever the manufacturer releases any product from the factory. Proper tracking mechanisms is not being implemented along with counterfeit checking mechanism from a point of origin until the point of sale.

Hence, there is a need for an improved system and method for authentication of a product during sale to address the aforementioned issues.

### BRIEF DESCRIPTION

In accordance with one embodiment of the disclosure, a system for authentication of a product during sale is provided. The system includes one or more processors. The system also includes a registration module to register a plurality of users on a centralized platform. The centralized platform comprises a database, wherein the database is associated with a manufacturer of the product. The system also includes a data retrieving module to retrieve data as provided by the plurality of users via the registration module. The system also includes a unique code generation module to generate a unique product code for real time analysis of the product. The system also includes a scanning module to detect the plurality of product details upon scanning the unique product code generated by the unique code generation module. The system also includes a product authentication module to authenticate the product during sale upon detecting the plurality of product details. The authenticity of the product during sale is determined by verifying a status of the product based on one or more historic scanning data.

In accordance with one embodiment of the disclosure, a method for authenticating a product during sale is provided. The method includes registering a plurality of users on a centralized platform. The method also includes retrieving data as provided by the plurality of users. The method also includes generating generate a unique product code for real time analysis of the product. The method also includes detecting the plurality of product details upon scanning the unique product code. The method also includes authenticating the product during sale upon detecting the plurality of product details.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representation of a system to for authentication of a product during sale in accordance with an embodiment of the present disclosure;

FIG. 2 is a block diagram representation of a processor of the system of FIG. 1 in accordance with an embodiment of the present disclosure;

FIG. 3 is a bock diagram representation of an embodiment representing the system for authentication of the product during sale of FIG. 1 in accordance of an embodiment of the present disclosure;

FIG. 4 is a block diagram of a computer or a server in accordance with an embodiment of the present disclosure; and

FIG. 5 is a flowchart representing the steps of a method for authenticating a product during sale in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated online platform, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or subsystems or elements or structures or components preceded by “comprises . . . a” does not, without more constraints, preclude the existence of other devices, subsystems, elements, structures, components, additional devices, additional subsystems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to system and method for authentication of a product during sale. As used herein, the term “authentication” is defined as the process or action of proving or showing something to be true, genuine, or valid.

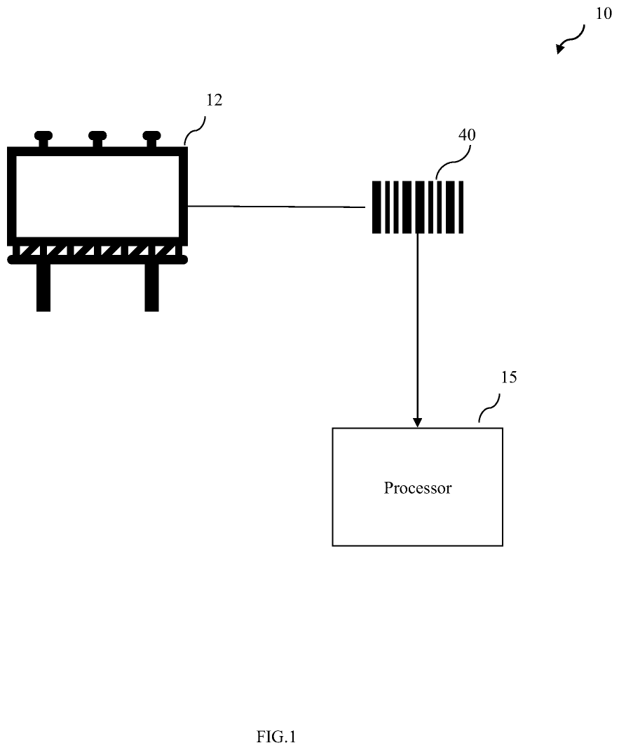

FIG. 1 is a block diagram representation of a system to for authentication of a product during sale in accordance with an embodiment of the present disclosure. The system 10 includes one or more processors 15. The system is used to determine the authenticity of the product by checking whether the product 12 is sold or not, upon scanning a unique product code 40 associated to the product 12.

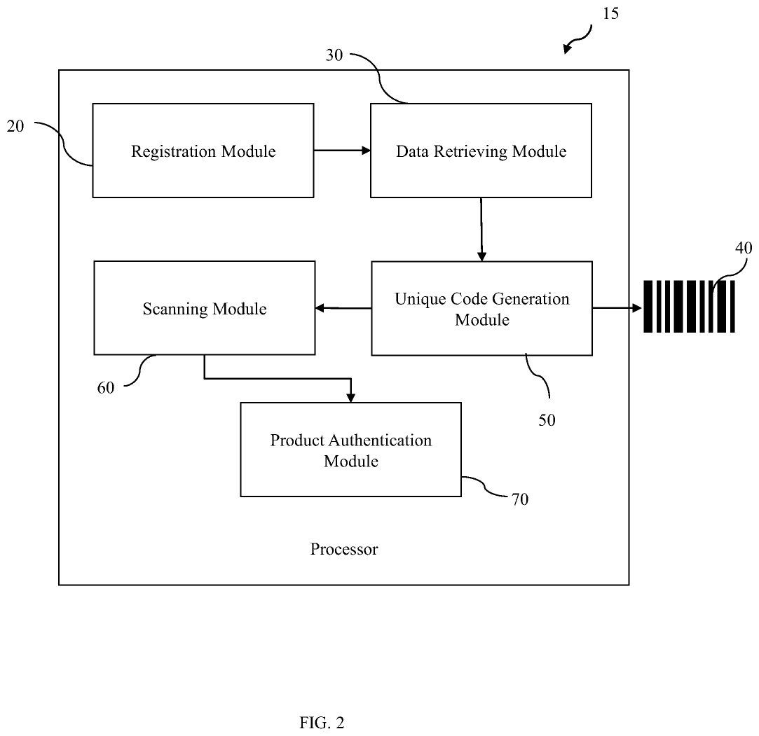

FIG. 2 is a block diagram representation of a processor of the system 10 of FIG. 1 in accordance with an embodiment of the present disclosure. The system 10 includes a registration module 20 to register multiple users on a centralized platform, wherein the centralised platform comprises a database. The database is associated with a manufacturer of the product 12. In one embodiment, the product 12 may be an article or substance that is manufactured or refined for sale. In one embodiment, the multiple users may include a manufacturer, a seller and an end customer. Here, in such embodiment, the end customer is referred to as an individual who is not permitted sell the product further. In operation, a manufacturer before selling of the product 12, for proper indication of authentication of the product 12 may register on the centralised platform. The system 10 enables regular checking at different hierarchy level of any supply chain.

The system 10 also includes a data retrieving module 30 to retrieve data as provided by the multiple users via the registration module 20. In one embodiment, the retrieved data may represent product details, details corresponding to each of the registered multiple users. In one exemplary embodiment, the details may comprise details of the manufacturer and a current buyer. As used herein, the term “manufacturer” is defined as a person or a company that makes goods for sale. Also, the “buyer” is referred to the person who will be owning the product after change of ownership. In one embodiment, the buyer includes a distributor or an end customer.

In one specific embodiment, the product details may include manufacturing date, expiry date, making details and the like. In another specific embodiment, the details corresponding to each manufacturer may include manufacturer name, manufacturer address and the like. In yet another specific embodiment, the details corresponding to each buyer comprises buyer name, buyer address, buying date and the like.

Furthermore, in another exemplary embodiment, the data retrieving module 30 may retrieve data from the manufacturer of the product 12 through manual input or other mechanisms. Such retrieved data may be vital for later judging of counterfeit products. As used herein, the term “counterfeit” may be defined as exact imitation of something valuable with the intention to deceive or defraud.

The system 10 also includes a unique code generation module 50 to generate a unique product code 40 for real time analysis of the product 12. The unique product code 40 includes multiple product details. In one embodiment, the multiple product details may include one or more details associated to manufacturing of the product 12, one or more details representative of the manufacturer of the product 12, one or more details associated to the historic scanning data of the product 12, or a combination thereof.

In one embodiment, the unique product code 40 may include a one-dimensional code or a multi-dimensional code. In such embodiment, the generated unique product code 40 is bounded over the product packaging. Here, encryption technique may be used by the unique code generation module 50 for generation of the unique product code 40. Here, the multi-dimensional code may comprise a two-dimensional code, a three-dimensional code and the like. In such embodiment, the unique product code 40 may include one of a bar code, a quick response (QR) code or the like.

The system 10 also includes a scanning module 60 to detect the multiple product details upon scanning the unique product code 40 generated by the unique code generation module 50. The scanning is being performed by one or more scanning devices. In one embodiment, the multiple user may scan the unique product code to identify the status and authenticity of the product 12 in real time. In one specific embodiment, the one or more scanning device may include a scanning unit in a mobile device.

Furthermore, the system 10 includes a product authentication module 70 to authenticate the product during sale upon detecting the multiple product details by the scanning module 60. The authenticity of the product 12 during sale is determined by verifying a status of the product 12 based on one or more historic scanning data. In one exemplary embodiment, the multiple product details to detect authenticity of the product 12 is obtained upon decryption of the unique product code on scanning the unique product code 40.

In one exemplary embodiment, the system 12 may include a product data transmission module to transmit the scanned unique product code 40 to the database for verification of the product. In such embodiment, notification may be in a form of a text notification, a voice notification, a multimedia notification or the like. Here, the notification may include all the related details of the product, manufacturer and buyer. In one specific embodiment, if the product 12 is already being sold to another buyer, the product authentication module 70 will provide the details about the ownership after verifying the product details in the database.

Furthermore, the system 10 is configured to store the details corresponding to the product 12 for the intimation during authentication and the generated unique product code 40 associated with the generated product code in the database. The database may be stored in a remote storage unit such as a cloud storage unit or a local storage unit.

In one exemplary embodiment, the product authentication module 70 may generate one or more verification signatures to the user representative of the identified product 12. The product authentication module 70 may also be configured to receive feedback from the user representative of the verification of the product 15 weather the signatures are present on the product 15 or not. The verification signatures can be textual tips, pictorial tips, or combination thereof

In another exemplary embodiment, the system 10 may include a recommendation module which may be configured to recommend the authentic product 15 to one or more other users based on the feedback of the user which may indicate if the product 15 is unauthentic or counterfeit.

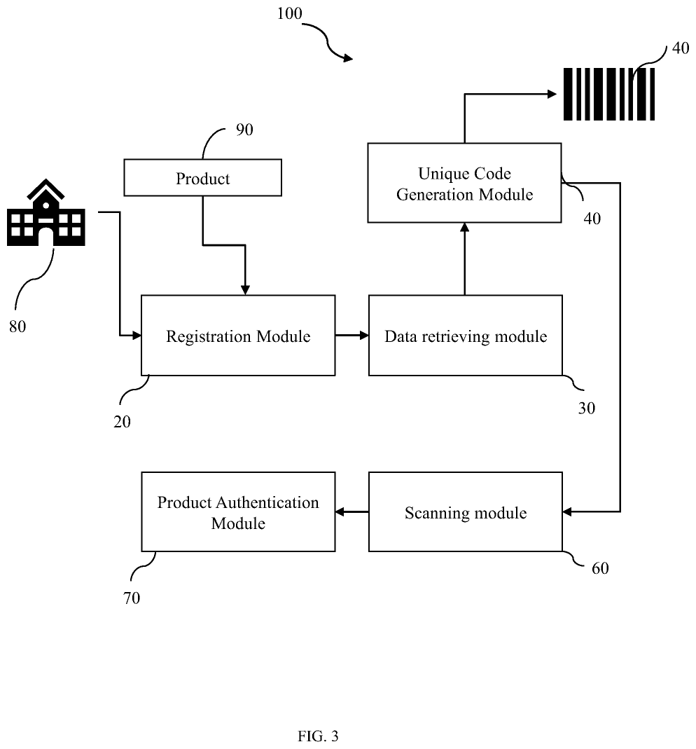

FIG. 3 is a block diagram representation of an embodiment representing the system 100 for authentication of the product during sale of FIG. 1 in accordance of an embodiment of the present disclosure. At first instance, a manufacturer X 80 registers on the centralised platform through the registration module 20. Prior to the selling of a product Y 90, the manufacturer X 80 may provide details of the product Y 90 as well ownership details of the product Y 90 to the data retrieving module 30, which is stored in the database. Based on all the details the unique product code is generated.

Further, the product code generation module 40 is generates a bar code 100 corresponding to the product Y 90. The bar code 40 is attached over the product Y 90. Also, during, the time of selling the product Y 90, the manufacturer X 80 enters the details of the buyer in the system 10 either manually or through other mechanisms.

Furthermore, a scanning module 60 enables scanning of the bar code 40, to detect the product details of the product Y 90 upon scanning the unique product code using a scanner. Further, the product authentication module 70 authenticates the product Y 90 during sale upon detecting the product details when the bar code is scanned by a buyer. In one situation, if the bar code 40 associated with the product Y 90 is fake, the product authentication module 70 will intimate the status to the manufacturer as well as the buyer after verifying with the database, and thus disclosing the authenticity of the product.

The registration module 20, the data retrieving module 30, the unique code generation module 40, the scanning module 60 and the product authentication module 70 of FIG. 2 is substantially similar to a registration module 20, a data retrieving module 30, a unique code generation module 40, a scanning module 60 and a product authentication module 70 of FIG. 1.

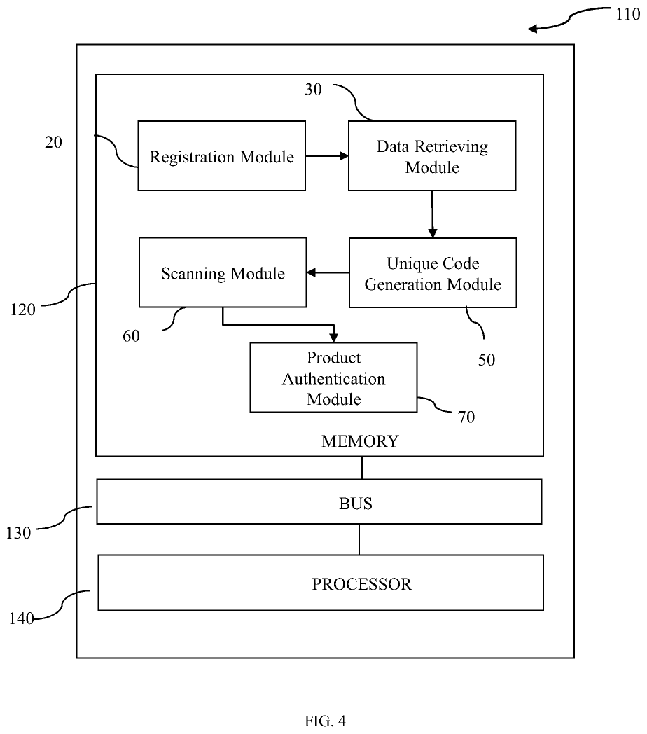

FIG. 4 is a block diagram of a computer or a server 110 in accordance with an embodiment of the present disclosure. The server 110 includes processors 140, and memory 120 coupled to the processor(s) 140 via a bus 130.

The processor(s) 140, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof

The memory 120 includes a plurality of modules stored in the form of executable program which instructs the processor 140 to perform the method steps illustrated in FIG. 1. The memory 120 has following modules: the registration module 20, the data retrieving module 30, the unique code generation module 50, the scanning module 60 and the product authentication module 70.

The registration module is configured to register a plurality of users on a centralised platform. The data retrieving module 30 is configured to retrieve data as provided by the plurality of users. The unique code generation module 50 is configured to generate a unique product code for real time analysis of the product. The scanning module 60 configured to detect the plurality of product details upon scanning the unique product code. The product authentication module 70 is configured to authenticate the product during sale upon detecting the plurality of product details.

Computer memory elements may include any suitable memory device(s) for storing data and executable program, such as read only memory, random access memory, erasable programmable read only memory, electrically erasable programmable read only memory, hard drive, removable media drive for handling memory cards and the like. Embodiments of the present subject matter may be implemented in conjunction with program modules, including functions, procedures, data structures, and application programs, for performing tasks, or defining abstract data types or low-level hardware contexts. Executable program stored on any of the above-mentioned storage media may be executable by the processor(s) 140.

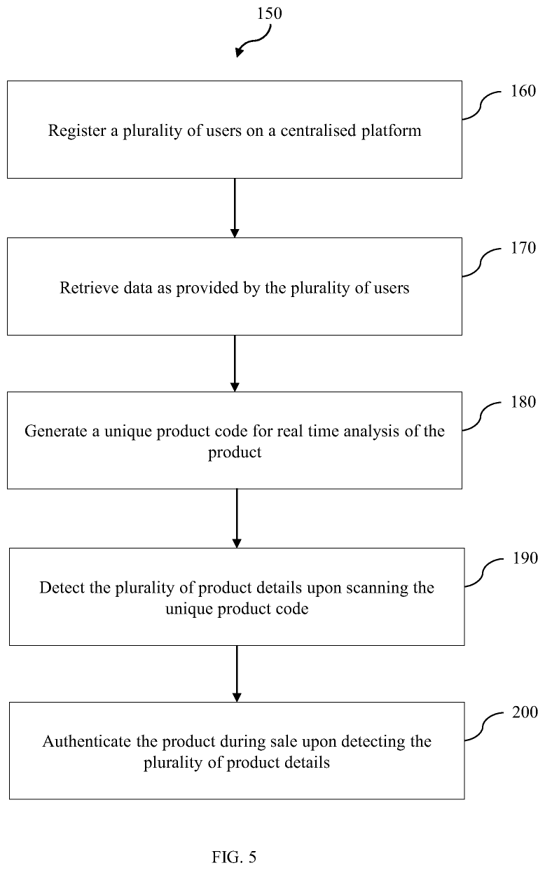

FIG. 5 is a flowchart representing the steps of a method 150 for authenticating a product during sale in accordance with an embodiment of the present disclosure. The method 150 includes registering multiple users on a centralised platform in step 160. The centralised platform includes a database. The database is associated with a manufacturer of the product. In one embodiment, registering multiple user may include registering multiple users by a registration module. In one embodiment, registering multiple user may include registering a manufacturer, a seller and an end customer on the centralised platform.

The method 150 also includes retrieving data as provided by the multiple users in step 170. In one embodiment, retrieving data may include retrieving data by a data retrieving module. Furthermore, the method 150 includes generating a unique product code for real time analysis of the product in step 180. In one embodiment, generating the unique product code includes generating the unique product code by a unique code generation module. The unique product code includes a plurality of product details.

The method 150 also includes detecting multiple product details upon scanning the unique product code in step 190. In one embodiment, detecting multiple product details may include detecting multiple product details by a scanning module. In one exemplary embodiment, detecting multiple product details includes detecting multiple product details upon comparing multiple product details with a set of pre-stored details from the database.

The method 150 also includes authenticating the product during sale upon detecting the multiple product details in step 200. The authenticity of the product during sale is determined by verifying a status of the product based on one or more historic scanning data. In one embodiment, authenticating the product may include authenticating the product by a product authentication module. In one exemplary embodiment, authenticating the product during sale upon detecting the multiple product details may include authenticating of the product upon decrypting of the unique product code on scanning the unique product code.

In one exemplary embodiment, the method 150 may further include transmitting the scanned unique product code to the database for verification of the product. In such embodiment, transmitting the scanned unique product code may include transmitting the scanned unique product code by a product data transmission module.

Various embodiments of the present disclosure enable the system to provide a platform for the consumer to verify the product identity and labelling via handheld devices such as a mobile, a tablet which has capabilities to scan the unique product code by connecting to the manufacturer directly. Any product manufacturer who wanted to provide an additional service to his consumer, build a reputation and log-term relation with consumer and empower them to direct the consumer to his product and strength them to buy the same. The manufacturer can be most compliant to the international standards for the labelling law. Any consumer can use the system while buying the product or after purchasing the product or till the time they can manage to scan the unique product code to connect to the database.

In addition, the system keeps a track of repetitive entries of the unique product code being scanned and if they are from the same number of the same user, then the system ignores the same, if needed the system can implement counter checks on these repetitive entries. In such scenarios, the system will detect the second entry of the same unique ID and sold entry in case someone manages to copy the unique product code and manage to put it on the fake product, which helps the law enforcement agencies to take corrective actions.

Also, in a situation, if the fake product get sold first and the genuine product is got scanned for the second time the system will flag the cautious warning to the consumer, now the consumer can verify other details such as the genuineness of the seller, manufacturing the date, seller registration and the like. The above-mentioned points enable a complete supply chain management system to be built around the same.

Furthermore, the system keeps the manufacturer informed about the duplicate product in the market with the exact location. The system also enables an integrated payment and independent billing process. Also, real-time cart or inventory tracking can be achieved by using this system by tracking the authenticity and verifying the product using the unique product code. The system also enables the batch scanning process in an inventory. Also, the system enables an Electronic Ledger Integration provision and/or hyper ledger integration provision to ease the process.

The system also enables the user to further investigation to find out the source and availability of fake products by integrating the system to a block chain platform. In addition, the system can track the geolocation of the product, who is the seller, who is the Consumer at which location the activity is happening, and the like. Also, the system can function as a standalone virtual point of sale (POS) system. Furthermore, the system focuses on involvement of active buyers. Also, the system can be used for running advertising campaign, promotional activities, formulating loyalty programs. In addition, discount coupon generation and integration can be merged with the system. Also, multiple such systems can be synced with each other to form a multi system sync.

Moreover, the system eases the functioning by adapting or integrating existing radio frequency identifiers (RFID) or any similar tracking system having a hardware. Also, the system can be integration to present software and apps such as customer relationship management, enterprise resource planning, inventory management system, supply chain management, point of sales, labeling and scanning software and applications.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

I/We claim:

1. A system for authentication of a product during sale comprising:
one or more processors;
a registration module operable by one or more processors, wherein the registration module is configured to register a plurality of users on a centralised platform, wherein the centralised platform comprises a database, wherein the database is associated with a manufacturer of the product;
a data retrieving module operable by the one or more processors, wherein the data retrieving module is configured to retrieve data as provided by the plurality of users via the registration module;
a unique code generation module operable by the one or more processors, wherein the unique code generation module is configured to generate a unique product code for real time analysis of the product, wherein the unique product code comprises a plurality of product details;
a scanning module operable by the one or more processors, wherein the scanning module is configured to detect the plurality of product details upon scanning the unique product code generated by the unique code generation module, wherein the scanning is being performed by one or more scanning devices; and
a product authentication module operable by the one or more processors, wherein the product authentication module is configured to authenticate the product during sale upon detecting the plurality of product details by the scanning module, wherein the authenticity of the product during sale is determined by verifying a status of the product based on one or more historic scanning data.

2. The system as claimed in claim 1, wherein the plurality of users comprises a manufacturer, a seller and an end customer.

3. The system as claimed in claim 1 wherein the plurality of product details comprises one or more details associated to manufacturing of the product, one or more details representative of a manufacturer of the product, one or more details associated to the historic scanning data of the product, or a combination thereof.

4. The system as claimed in claim 1, wherein the unique product code comprises of a one-dimensional code or a multi-dimensional code.

5. The system as claimed in claim 1, wherein the plurality of product details to detect authenticity of the product is obtained upon decryption of the unique product code on scanning the unique product code.

6. The system as claimed in claim 1, comprises a product data transmission module operable by the one or more processors, wherein the product data transmission module is configured to transmit the scanned unique product code to the database for verification of the product.

7. A method for authenticating a product during sale comprising:
registering, by a registration module, a plurality of users on a centralised platform, wherein a centralised platform comprises a database, wherein the database is associated with a manufacturer of the product;
retrieving, by a data retrieving module, data as provided by the plurality of users;
generating, by a unique code generation module, a unique product code for real time analysis of the product, wherein the unique product code comprises a plurality of product details;
detecting, by a scanning module, the plurality of product details upon scanning the unique product code; and
authenticating, by a product authentication module, the product during sale upon detecting the plurality of product details, wherein the authenticity of the product during sale is determined by verifying a status of the product based on one or more historic scanning data.

8. The method as claimed in claim 7, wherein registering the plurality of users comprises registering a manufacturer, a seller and an end customer on the centralised platform.

9. The method as claimed in claim 7, wherein authenticating the product during sale upon detecting the plurality of product details comprises authenticating of the product upon decrypting of the unique product code on scanning the unique product code.

10. The method as claimed in claim 7, comprises transmitting, by a product data transmission module, the scanned unique product code to the database for verification of the product.
